(19) United States
(12) Patent Application Publication
(10) Pub. No.: US 2007/0019117 A1
(43) Pub. Date: Jan. 25, 2007

(54) Low noise block converter

(75) Inventor: Yoshiaki Nakano, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/491,127

(22) Filed: Jul. 24, 2006

(30) Foreign Application Priority Data
Jul. 25, 2005 (JP) 2005-215007

(51) Int. Cl. H04N 5/50

(52) U.S. Cl. 348/735

(57) ABSTRACT

A mixer generates intermediate frequency signals (lower intermediate frequency signals and higher intermediate frequency signals) from polarized wave signals received from satellites. The intermediate frequency signals are passed through path selecting switches which set up paths inside thereof so that the intermediate frequency signals selectively appear at selected output terminals. Adders add two non-frequency-range-overlapping outputs of the path selecting switches to generate composite signals. Thus, an LNB is realized which has limited frequency conversion circuit complexity.

This nonprovisional application claims priority under 35 U.S.C. § 119(a) on Patent Application No. 2005/215007 filed in Japan on Jul. 25, 2005, the entire contents of which are hereby incorporated by reference.

### FIELD OF THE INVENTION

The present invention relates in general to the low noise block converter (low noise block converter; hereinafter “LNB”) and in particular to those which are suitable to receiving a plurality of polarized wave signals transmitted from different satellites.

### BACKGROUND OF THE INVENTION

Conventional LNBs receive a plurality of polarized wave signals from different satellites and convert them to intermediate frequencies. Japanese Unexamined Patent Publication (Tokukai) 2004-350149 (published on Dec. 9, 2004), as an example, discloses an LNB containing: N frequency conversion circuits (N≧2); N first signal mixers; and a signal reorganizing circuit. Each frequency conversion circuit is associated with a different satellite. The N frequency conversion circuits receive M polarized wave signals (M≧2) from the respective N satellites. The frequency conversion circuits convert the frequency bands of the M polarized wave signals coming from the satellites down to non-overlapping M intermediate frequency bands. Each first signal mixer is associated with a different satellite. The N first signal mixers frequency-multiplex respectively the down-converted M polarized wave signals from the satellites to generate first composite signals. The signal reorganizing circuit selects at random M first possibly overlapping, composite signals from the N first composite signals. The signal reorganizing circuit then obtains one polarized wave signal from each of the selected first composite signals at random and frequency-multiplexes the obtained M polarized wave signals to generate a second composite signal. The processing enables not only a polarized wave signal from a satellite, but also multiple wave signals from multiple satellites, to be simultaneously transmitted over a single cable. The system is typically configured and operates as follows.

FIG. 19 shows an example of the configuration of an LNB 11 disclosed in Tokukai 2004-350149.

In the LNB 11, a plurality of satellites (two satellites 120A, 120B positioned at 110° and 119° in the example) transmits signals which are received by an antenna 100. Each signal is separated by a feedhorn 101 (101A for 110° and 101B for 119°) into a right-handed polarized wave and a left-handed polarized wave. Results are four signals (110° R, 110° L, 119° R, and 119° L). All the polarized wave signals are in the frequency range of 12.2 GHz to 12.7 GHz.

The four signals are passed through amplifiers 102 (102A for 110° R, 102B for 110° L, 102C for 119° R, and 102D for 119° L) and image removing filters and fed to the frequency converter 112.

The frequency converter 112, where block conversion takes place, contains mixers 103A, 103B, 104A, 104B and two local oscillators 109A, 109B. The mixer 103A is for 110° L; the mixer 103B for 119° L; the mixer 104A for 110° R; and the mixer 104B for 119° R. In this manner, each polarized wave signal path is provided with its own first mixer, which means the converter 112 has a total of four mixers. A local oscillator 109A oscillates at 11.25 GHz to supply a local oscillator signal to the mixers 103A, 103B. A local oscillator 109B oscillates at 14.35 GHz to supply a local oscillator signal to the mixers 104A, 104B.

The signal 110° L is multiplied by the 11.25-GHz local signal in the mixer 103A to obtain 950-MHz to 1450-MHz intermediate frequencies. The 110° R signal is multiplied by the 14.35-GHz local signal in the mixer 104A to obtain a 1650-MHz to 2150-MHz intermediate frequencies. By applying similar procedures to the signals from the 119° satellite, one can obtain 950-MHz to 1450-MHz intermediate frequencies for the 119° L signal and 1650-MHz to 2150-MHz intermediate frequencies for the 119° R signal.

The output of the mixer 103A is passed through a lowpass filter before being fed to a first adder 106A. The output of the mixer 104A is passed through a highpass filter before being fed to the first adder 106A. The output of the mixer 103B is passed through a lowpass filter before being fed to a first adder 106B. The output of the mixer 104B is passed through a highpass filter before being fed to the first adder 106B. Accordingly, the first adder 106A and the first adder 106B each produce a first frequency-multiplexed, composite signal of the high frequency band (H Band) signal and the low frequency band (L Band) signal with no frequency overlapping. As in the FIG. 19 example, the 950-MHz to 1450-MHz frequency range of the first composite signal output from the first adder 106A constitutes the 110° L signal, and the 1650-MHz to 2150-MHz frequency range constitutes the 110° R signal. Furthermore, the 950-MHz to 1450-MHz frequency range of the first composite signal output from the first adder 106B constitutes the 119° L signal, and the 1650-MHz to 2150-MHz frequency range constitutes the 119° R signal.

The first composite signals are fed to a signal reorganizing circuit 116. The circuit 116 contains N×M (2×4 in the figure) path selecting switches 105 and four frequency converters 118 (118A to 118D) with a pass-through function.

The path selecting switches 105 set up a signal path, determining from which of the switch output terminals out1 to out4 the input signals are output. The switch output terminals are connected to respective frequency converters 118. Each frequency converter 118 has two selectable paths, one providing a pass-through for a signal and the other routing through a mixer 119 (119A to 119D). The mixers 119A to 119D receive a 3.1-GHz local oscillator signal from a local oscillator 117.

The output of the frequency converter 118A is coupled to the filter 107A which passes a high frequency component (1650 MHz to 2150 MHz) of the frequency-multiplexed signal while blocking a low frequency component (950 MHz to 1450 MHz). The output of the frequency converter 118B is coupled to the filter 108A which passes a low frequency component (950 MHz to 1450 MHz) while blocking a high frequency component (1650 MHz to 2150 MHz). Likewise, the output of the frequency converter 118C is coupled to the filter 107B which passes a high frequency component (1650 MHz to 2150 MHz) of the frequency-multiplexed signal while blocking a low frequency component (950 MHz to 1450 MHz). The output of the frequency converter 118D is coupled to the filter 108B which passes a low frequency component (950 MHz to 1450 MHz) while blocking a high frequency component (1650 MHz to 2150 MHz).

In this configuration example, the output terminals out1, out2, out3, out4 of the path selecting switches 105 are connected to frequency converters with a pass-through function which in turn are connected to filters which pass a high frequency component, a low frequency component, a high frequency component, and a low frequency component respectively.

The outputs of the filters 107A, 108A are supplied to a second adder 110A. The outputs of the filters 107B, 108B are supplied to a second adder 110B. Each second adder 110 (110A, 110B) mixes a high frequency output signal and a low frequency output signal to produce a frequency-multiplexed signal for output from an LNB output terminal 111 (111A, 111B).

Next, the operation of the signal reorganizing circuit 116 will be described using a concrete example.

Suppose now that one wants to obtain 110° L and 119° L as a low frequency component and a high frequency component respectively at an output 1 of the LNB 11 (output from the LNB output terminal 111A). First, the path selecting switches 105 are set up so that the input signal at the input terminal inl appears at the output terminal out2. Also, the frequency converter 118B, coupled to the output terminal out2, is set up to provide a pass-through for an incoming signal. The filter 108A, located downstream of the frequency converter 118B, transmits only the 110° L signal, a low frequency component, to feed to a first input terminal of the second adder 110A which is connected to the output 1 of the LNB 11.

Next, the path selecting switches 105 are set up so that the input signal at the input terminal in2 appears at the output terminal out1. The frequency converter 118A, coupled to the output terminal out1, is set up to route an incoming signal through the mixer 119A. In other words, an incoming signal is frequency-converted with the 3.1-GHz local signal. At the input terminal in2, the 119° L signal is from 950 MHz to 1450 MHz, and the 119° R signal is from 1650 MHz to 2150 MHz. These signals are converted by the frequency converter 118A, the resultant 119° R and 119° L signals being from 950 MHz to 1450 MHz and from 1650 MHz to 2150 MHz respectively. The filter 107A, located downstream of the frequency converter 118A, transmits only the 119° L signal, a high frequency component, to feed to a second input terminal of the second adder 110A which is connected to the output 1 of the LNB 11. One can hence obtain the desired 110° L and 119° L signals as a low frequency component and a high frequency component respectively at the second adder 110A.

As in this example, the LNB 11 provides outputs all possible combinations by virtue of the path selection by the path selecting switches 105 and the pass-through/frequency conversion switching by the frequency converters 118.

To obtain a given polarized wave signal from the LNB, however, the signal reorganizing circuit undesirably needs mixers and a local oscillator which carry out frequency conversion again on the signal produced by frequency multiplexing. The necessity of the additional frequency conversion leads to the necessity of correspondingly increased precision in local frequency, which is achieved by the addition of a PLL or other frequency regulator devices. In terms of performance, the additional frequency conversion will also likely cause unwanted spurious oscillation, increased current consumption, higher internal temperatures due to the increased current consumption, and deteriorating NF (noise figure).

Other conventional LNB arrangements are disclosed in prior art documents like U.S. patent application 2004/0209584 (published Oct. 21, 2004), U.S. patent application 2004/0214537 (published Oct. 28, 2004), U.S. patent application 2004/0005296 (published Jan. 6, 2005), and U.S. patent application 2004/0209588 (published Oct. 21, 2004).

### SUMMARY OF THE INVENTION

The present invention has an objective to provide an LNB with a limited frequency conversion circuit complexity.

To achieve the objective, a low noise block converter of the present invention receives a plurality of polarized wave signals from a plurality of satellites. The low noise block converter includes: amplifying sections amplifying the plurality of polarized wave signals respectively; a frequency conversion section converting the plurality of polarized wave signals amplified by the amplifying sections into intermediate frequency signals in a plurality of frequency ranges; path selecting switches, provided with input terminals to which are fed the respective intermediate frequency signals generated by the frequency conversion section, which selectively establish paths connecting the input terminals to a plurality of output terminals so that the intermediate frequency signals fed to the input terminals are selectively output at selected ones of the plurality of output terminals; and adders adding more than one output of the path selecting switches to generate composite signals for output.

According to the arrangement, the polarized wave signals are amplified by the amplifying sections for subsequent frequency conversion in the frequency conversion section. The frequency conversion section generates intermediate frequency signals in a plurality of frequency ranges from the polarized wave signals through conversion. The path selecting switches selectively establish paths so that a plurality of intermediate frequency signals with no frequency range overlapping are coupled to the inputs of each adder. The adders generate composite signals in a plurality of frequency ranges with no frequency range overlapping. Therefore, frequency-multiplexed signals are obtained with no signal frequency conversion in the frequency conversion section and later stages.

Hence, an LNB is realized which has limited frequency conversion circuit complexity.

To achieve the objective, another low noise block converter of the present invention receives a plurality of polarized wave signals from a plurality of satellites. The low noise block converter includes: amplifying sections amplifying the plurality of polarized wave signals respectively; a frequency conversion section converting the plurality of polarized wave signals amplified by the amplifying sections into intermediate frequency signals in a plurality of frequency ranges; first adders adding the intermediate frequency signals in a plurality of frequency ranges supplied from the frequency conversion section for each polarized wave signal to generate first composite signals for output; path selecting switches, provided with input terminals to which are fed the respective first composite signals generated by the frequency conversion section, which selectively establish paths connecting the input terminals to a plurality of output terminals so that the first composite signals fed to the input terminals are selectively output at selected ones of the plurality of output terminals; filters, provided for the respective output terminals of the path selecting switches, through which outputs of the path selecting switches are passed; and second adders adding more than one output of the filters to generate second composite signals for output.

According to the arrangement, the polarized wave signals are amplified by the amplifying sections for subsequent frequency conversion in the frequency conversion section. The frequency conversion section converts the polarized wave signals into intermediate frequency signals in a plurality of frequency ranges. The first adders add the intermediate frequency signals in a plurality of frequency ranges for each polarized wave signal to generate first composite signals. The first composite signals are selectively output at selected output terminals of the path selecting switches. The first composite signals at the output terminals are passed through filters to preserve only some frequency components. A plurality of filter outputs with no frequency range overlapping is fed to each second adder. The second adders generate second composite signals in a plurality of frequency ranges with no frequency range overlapping. Therefore, frequency-multiplexed signals are obtained with no signal frequency conversion in the frequency conversion section and later stages.

Hence, an LNB is realized which has limited frequency conversion circuit complexity.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1, showing embodiment 1 of the present invention, is a block diagram illustrating the configuration of a major part of an LNB.

FIG. 2, showing embodiment 2 of the present invention, is a block diagram illustrating the configuration of a major part of an LNB.

FIG. 3 is a block diagram illustrating a variation of the configuration of the LNB in FIG. 2 where the first composite signal is generated in a different way.

FIG. 4(a), showing embodiment 3 of the present invention, is a block diagram illustrating the configuration of a part of an LNB.

FIG. 4(b) depicts the relationship between the frequency characteristics and disruptive waves of an image remove filter in the LNB in FIG. 4(a).

FIG. 5, showing embodiment 4 of the present invention, is a block diagram illustrating the configuration of a major part of an LNB.

FIG. 6 is a chart showing switch control patterns in the LNB in FIG. 5.

FIG. 7, showing embodiment 5 of the present invention, is a block diagram illustrating the configuration of a part of an LNB.

FIG. 8 is an illustration of a first signal spectrum depicting operation in relation to FIG. 7.

FIG. 9 is an illustration of a second signal spectrum depicting operation in relation to FIG. 7.

FIG. 10, showing embodiment 6 of the present invention, is a block diagram illustrating the configuration of a part of an LNB.

FIG. 11, showing embodiment 7 of the present invention, is a block diagram illustrating the configuration of a part of an LNB.

FIGS. 12(a) and 12(b), showing embodiment 8 of the present invention, are block diagrams illustrating the configuration of a part of an LNB.

FIG. 13, showing embodiment 9 of the present invention, is a block diagram illustrating the configuration of a major part of an LNB.

FIG. 14, showing embodiment 10 of the present invention, is a block diagram illustrating the configuration of a major part of an LNB.

FIG. 15, showing embodiment 11 of the present invention, a block diagram illustrating the configuration of a part of an LNB.

FIG. 16, showing embodiment 12 of the present invention, is a block diagram illustrating the configuration of a part of an LNB.

FIG. 17, showing embodiment 13 of the present invention, is a block diagram illustrating the configuration of a major part of an LNB.

FIG. 18, showing embodiment 14 of the present invention, is a block diagram illustrating the configuration of a major part of an LNB.

FIG. 19, showing conventional art, is a block diagram illustrating the configuration of a major part of an LNB.

### DESCRIPTION OF THE EMBODIMENTS

Embodiment 1

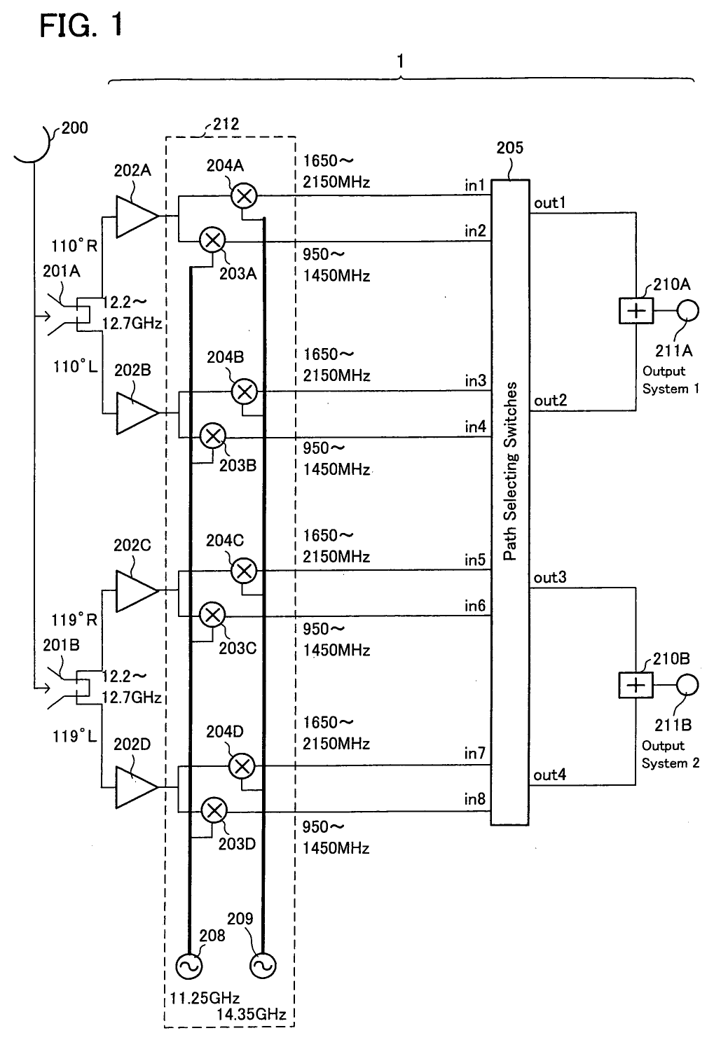

The following will describe an embodiment of the present invention in reference to FIG. 1.

FIG. 1 shows the configuration of an LNB 1 in accordance with the present embodiment. Assume the same satellites as in the BACKGROUND OF THE INVENTION, as an example.

The LNB 1 includes amplifiers (amplifying sections) 202 (202A for 110° R, 202B for 110° L, 202C for 119° R, and 202D for 119° L), a frequency converter (frequency conversion section) 212, path selecting switches 205, and adders 210 (210A for an output system 1, and 210B for an output system 2). Feedhorns 201 may be integrated with the LNB 1 (detailed later).

Downlink signals from the two satellites are received by an antenna 200 and supplied to the feedhorns 201 (201A for 110°, and 201B for 119°). The feedhorns 201 have functions of distinguishing between satellites and separating polarized wave signals. Accordingly, each polarized wave signal from the satellites is separated into a right-handed polarized wave and a left-handed polarized wave. Results are a total of four signals (110° R, 110° L, 119° R, and 119° L). All the polarized wave signals are in the frequency range of 12.2 GHz to 12.7 GHz.

The separated polarized wave signals are amplified by the amplifiers 202A to 202D respectively. The amplifier outputs are supplied to the frequency converter 212. The frequency converter 212 has a low frequency conversion path and a high frequency conversion path for each polarized wave signal. Each low frequency conversion path includes a mixer 203 (203A for 110° R, 203B for 110° L, 203C for 119° R, and 203D for 119° L). Each high frequency conversion path includes a mixer 204 (204A for 110° R, 204B for 110° L, 204C for 119° R, and 204D for 119° L). A local oscillator 208 supplies a common 11.25-GHz local oscillator signal to the mixers 203A to 203D. A local oscillator 209 supplies a common 14.35-GHz local oscillator signal to the mixers 204A to 204D. In this manner, the two sets of mixers associated respectively with the polarized wave signals receive local oscillator signals of different frequencies.

Each polarized wave signal, as fed to the frequency converter 212, is routed along two branch paths. Along the low frequency conversion path, the signal is frequency-converted to a lower intermediate frequency signal. Along the high frequency conversion path, the signal is frequency-converted to a higher intermediate frequency signal. The lower intermediate frequency here ranges from 950 MHz to 1450 MHz, and the higher intermediate frequency from 1650 MHz to 2150 MHz. In this manner, the polarized wave signals are block-converted in advance to a plurality of intermediate frequency signals whose frequency ranges have no overlapping.

The output signals (intermediate frequency signals) of the frequency converter 212 are coupled to the respective input terminals in of the path selecting switches 205. The path selecting switches 205 are N×M switches enabling selection of paths connecting the input terminals in to output terminals out. Of the intermediate frequency signals fed at the input terminals in, those which are selected appear at a plurality of output terminals out which are also selected. If an input terminal in is made up of a pair of differential input terminals or if an output terminal out is made up of a pair of differential output terminals, each pair of input or output differential terminals is regarded as a single input or output terminal.

There are eight input terminals in: inl for the higher intermediate frequency signal of 110° R, in2 for the lower intermediate frequency signal of 110° R, in3 for the higher intermediate frequency signal of 110° L, in4 for the lower intermediate frequency signal of 110° L, in5 for the higher intermediate frequency signal of 119° R, in6 for the lower intermediate frequency signal of 119° R, in7 for the higher intermediate frequency signal of 119° L, and in8 for the lower intermediate frequency signal of 119° L. There are four output terminals out: out1 to out4. Each one of the input terminals inl to in8 is selectively connectable to any one of the output terminals out1 to out4. For example, the input terminal in4 can be connected to the output terminal out1, the input terminal in7 to the output terminal out2, the input terminal in1 to the output terminal out3, and the input terminal in6 to the output terminal out4. One or more input terminals in1 to in8 may be connected to none of the output terminals out.

The adder 210A adds the output signal which appears at the output terminal out1 and the output signal which appears at the output terminal out2 of the path selecting switches 205, to generate a composite signal. The adder 210A outputs the composite signal from an output terminal 211A of the output system 1. The adder 210B adds the output signal which appears at the output terminal out3 and the output signal which appears at the output terminal out4 of the path selecting switches 205, to generate a composite signal. The adder 210B outputs the composite signal from an output terminal 211B of the output system 2. The path selecting switches 205 are set up to establish such paths that one of the output terminals out1 and out2 is assigned to a higher intermediate frequency signal, and the other to a lower intermediate frequency signal which has no frequency range overlapping with the higher intermediate frequency signal and also that one of the output terminals out3 and out4 is assigned to a higher intermediate frequency signal, and the other to a lower intermediate frequency signal which has no frequency range overlapping with the higher intermediate frequency signal. Thus, the adders 210A, 210B can add signals with no frequency overlapping and generate desirable frequency-multiplexed, composite signals. One either one of the output system 1 and the output system 2 may output a composite signal.

In this manner, according to the present embodiment, the polarized wave signals are amplified by the amplifiers 202 and fed to the frequency converter 212 for frequency conversion. The intermediate frequency signals in a plurality of frequency ranges obtained from the conversion of the polarized wave signals in the frequency converter 212 are routed as set up by the path selecting switches 205. Thus, a plurality of intermediate frequency signals with no frequency range overlapping is fed to single adders 210. The adders 210 generate composite signals in a plurality of frequency ranges with no frequency range overlapping. Therefore, no signal frequency conversion is needed in stages following the frequency converter 212, to generate a frequency-multiplexed signal.

Hence, the embodiment provides an LNB with a limited frequency conversion circuit complexity.

In addition, the LNB 1 can simultaneously output not only a polarized wave signal from one satellite, but also multiple polarized wave signals from multiple satellites, over a single cable, delivering the same function as publicly known documents teach.

The LNB 1 contains a frequency converter only for the generation of the intermediate frequency signals. Each signal path includes only one site where the signal is frequency-converted. The LNB 1 therefore contains fewer circuits than conventional LNBs (those which would be contained in frequency converters are omitted: e.g., mixer circuit, local oscillator, PLL frequency synthesizer for local oscillator frequency regulation, referential quartz oscillator for PLL frequency synthesizer). The omission of these circuits reduces current consumption, circuit complexity, and costs. Especially, where circuit integration is possible, the LNB 1 is more compact and has fewer IC-peripheral circuits because of the reduced circuit complexity. Large cost reductions are achieved. In terms of performance, the fewer signal processing blocks result in less noise and an improved NF which is an essential performance factor to a receiver. Quality degradation of received signals caused by higher order harmonics in the local oscillators is lessened. Quality degradation of received signals caused by digital signal processing in the PLL circuit is also lessened. Reduced current consumption leads to limited heating, which will contribute to an extended product lifetime. Other effects are also expected.

The present embodiment is, needless to say, applicable to three or more satellites or satellites transmitting three or more polarized wave signals. The same can be said about the frequency converter 212 generating intermediate frequency signals in three or more frequency ranges.

Embodiment 2

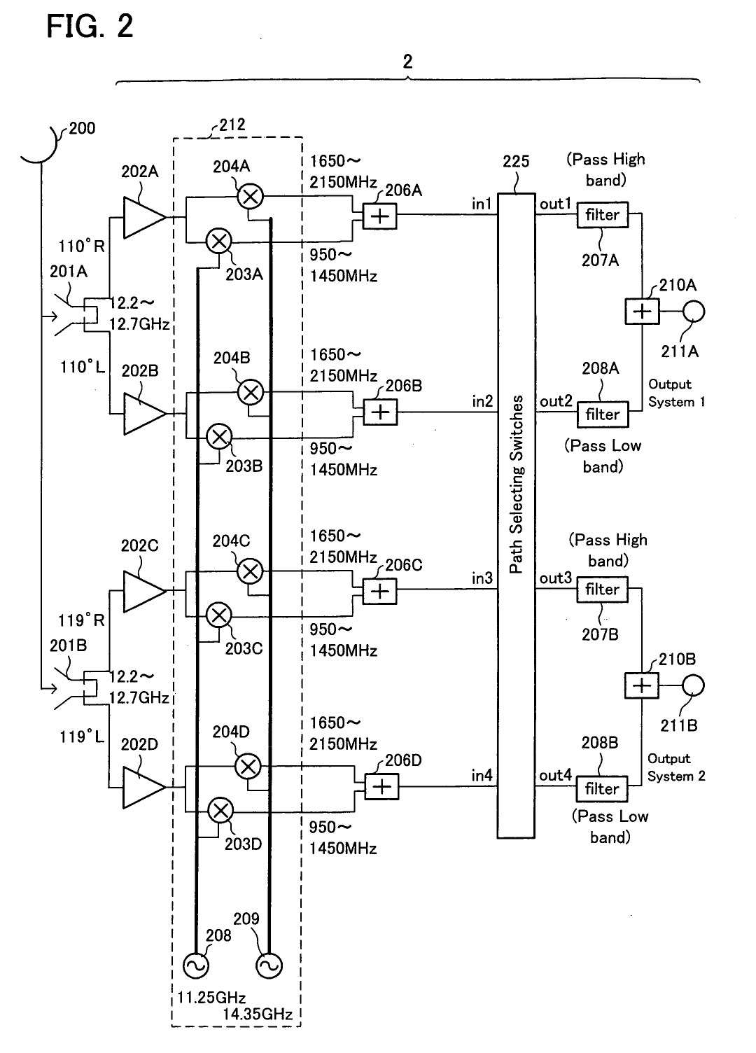

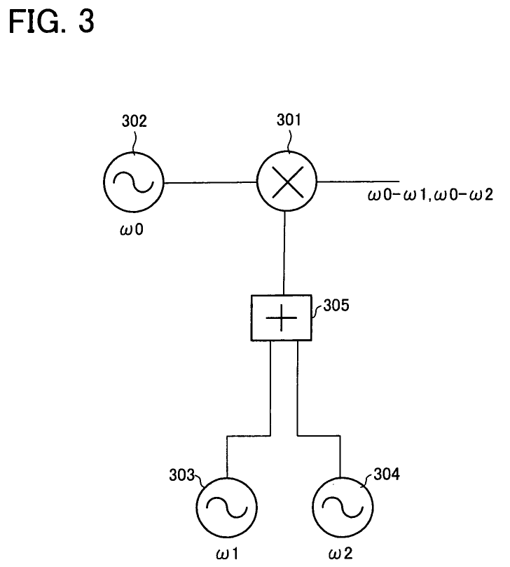

The following will describe another embodiment of the present invention in reference to FIGS. 2 and 3.

FIG. 2 shows the configuration of an LNB 2 in accordance with the present embodiment. Assume the same satellites as in the BACKGROUND OF THE INVENTION, as an example.

The LNB 2 includes amplifiers (amplifying sections) 202 (202A for 110° R, 202B for 110° L, 202C for 119° R, and 202D for 119° L), a frequency converter (frequency conversion section) 212, adders 206 (206A for 110° R, 206B for 110° L, 206C for 119° R, and 206D for 119° L), path selecting switches 225, filters 207, 208 (207A, 207B, 208A, and 208B), and adders 210 (210A for an output system 1, and 210B for an output system 2). Feedhorns 201 may be integrated with the LNB 2 (detailed later).

Downlink signals from the two satellites are received by an antenna 200 and supplied to the feedhorns 201 (201A for 110°, and 201B for 119°). The feedhorns 201 have functions of distinguishing between satellites and separating polarized wave signals. Accordingly, each polarized wave signal from the satellites is separated into a right-handed polarized wave and a left-handed polarized wave. Results are a total of four signal (110° R, 110° L, 119° R, and 119° L). All the polarized wave signals are in the frequency range of 12.2 GHz to 12.7 GHz.

The separated polarized wave signals are amplified by the amplifiers 202A to 202D respectively. The amplifier outputs are supplied to the frequency converter 212. The frequency converter 212 has a low frequency conversion path and a high frequency conversion path for each polarized wave signal. Each low frequency conversion path includes a mixer 203 (203A for 110° R, 203B for 110° L, 203C for 119° R, and 203D for 119° L). Each high frequency conversion path includes a mixer 204 (204A for 110° R, 204B for 110° L, 204C for 119° R, and 204D for 119° L). A local oscillator 208 supplies a common 11.25-GHz local oscillator signal to the mixers 203A to 203D. A local oscillator 209 supplies a common 14.35-GHz local oscillator signal to the mixers 204A to 204D. In this manner, the two sets of mixers associated respectively with the polarized wave signals receive local oscillator signals of different frequencies.

Each polarized wave signal, as fed to the frequency converter 212, is routed along two branch paths. Along the low frequency conversion path, the signal is frequency-converted to a lower intermediate frequency signal. Along the high frequency conversion path., the signal is frequency-converted to a higher intermediate frequency signal. The lower intermediate frequency here ranges from 950 MHz to 1450 MHz, and the higher intermediate frequency from 1650 MHz to 2150 MHz. In this manner, the polarized wave signals are block-converted in advance to a plurality of intermediate frequency signals whose frequency ranges have no overlapping.

For each polarized wave signal, the (first) adders 206 add a higher intermediate frequency signal output and a lower intermediate frequency signal output from the frequency converter 212 to generate a composite signal for output. The adder 206A adds the higher intermediate frequency signal output from the mixer 204A and the lower intermediate frequency signal output from the mixer 203A to generate a composite signal. The adder 206B adds the higher intermediate frequency signal output from the mixer 204B and the lower intermediate frequency signal output from the mixer 203B to generate a composite signal. The adder 206C adds the higher intermediate frequency signal output from the mixer 204C and the lower intermediate frequency signal output from the mixer 203C to generate a composite signal. The adder 206D adds the higher intermediate frequency signal output from the mixer 204D and the lower intermediate frequency signal output from the mixer 203D to generate a composite signal. The composite signals thus generated will be referred to as the first composite signals.

The first composite signals generated by the adders 206 are coupled to the respective input terminals in of the path selecting switches 225. The signal outputs from the adders 206 are supplied to the path selecting switches 225. The path selecting switches 225 are N×M switches enabling selection of paths connecting the input terminals in to output terminals out. Of the first composite signals fed at the input terminals in, those which are selected appear at a plurality of output terminals out which are also selected.

There are four input terminals in: in1 for 110° R, in2 for 110° L, in3 for 119° R, and in4 for 119° L. There are four output terminals out, out1 to out4. Each one of the input terminals in1 to in4 is selectively connectable to any one of the output terminals out1 to out4. For example, the input terminal in4 can be connected to the output terminal out2, the input terminal in4 to the output terminal out1, the input terminal in1 to the output terminal out3, and the input terminal in3 to the output terminal out4. One or more input terminals in may be connected to none of the output terminals out.

The filter 207A is a high frequency component select filter which filters the first composite signal output which appears at the output terminal out1 of the path selecting switches 225, transmitting a high frequency component. The filter 208A is a low frequency component select filter which filters the first composite signal output which appears at the output terminal out2 of the path selecting switches 225, transmitting a low frequency component. The filter 207B is a high frequency component select filter which filters the first composite signal output which appears at the output terminal out3 of the path selecting switches 225, transmitting a high frequency component. The filter 208B is a low frequency component select filter which filters the first composite signal output which appears at the output terminal out4 of the path selecting switches 225, transmitting a low frequency component.

The (second) adder 210A adds the signal output from the filter 207A and the signal output from the filter 208A to generate a composite signal for output via the output terminal 211A of the output system 1. Likewise, the (second) adder 210B adds the signal output from the filter 207B and the signal output from the filter 208B to generate a composite signal for output via the output terminal 211B of the output system 2. The composite signals thus generated will be referred to as the second composite signals. The second composite signals are a combination of a high frequency range component and a low frequency range component with no frequency range overlapping. A desirable frequency-multiplexed, composite signal is obtained. It may be only either one of the output system 1 and the output system 2 that outputs a second composite signal.

In this manner, according to the present embodiment, the polarized wave signals are amplified by the amplifiers 202 and fed to the frequency converter 212 for frequency conversion. For each polarized wave signal, the adder 206 adds together the intermediate frequency signals in a plurality of frequency ranges obtained from the conversion of the polarized wave signals in the frequency converter 212, to generate the first composite signals. Of these first composite signals, the selected ones are output via the selected output terminals of the path selecting switches 225. The first composite signal outputs via the output terminals are passed through the filters 207 or 208 where some frequency component is transmitted. The outputs of a plurality of filters 207, 208 with no frequency range overlapping are fed to single adders 210. The adders 210 generate second composite signals in a plurality of frequency ranges with no frequency range overlapping. Therefore, no signal frequency conversion is needed in stages following the frequency converter 212, to generate a frequency-multiplexed signal.

Hence, the embodiment provides an LNB with a limited frequency conversion circuit complexity.

In addition, the LNB 2 can simultaneously output not only a polarized wave signal from one satellite, but also multiple polarized wave signals from multiple satellites, over a single cable, delivering the same function as publicly known documents teach.

The LNB 2 contains a frequency converter only for the generation of the intermediate frequency signals. Each signal path includes only one site where the signal is frequency-converted. The LNB 2 therefore contains fewer circuits than conventional LNBs (those which would be contained in frequency converters are omitted: e.g., mixer circuit, local oscillator, PLL frequency synthesizer for local oscillator frequency regulation, referential quartz oscillator for PLL frequency synthesizer). The omission of these circuits reduces current consumption, circuit complexity, and costs. Especially, where circuit integration is possible, the LNB 2 is more compact and has fewer IC-peripheral circuits because of the reduced circuit complexity. Large cost reductions are achieved. In terms of performance, the fewer signal processing blocks result in less noise and an improved NF which is an essential performance factor to a receiver. Quality degradation of received signals caused by higher order harmonics in the local oscillator is lessened. Quality degradation of received signals caused by digital signal processing in the PLL circuit is also lessened. Reduced current consumption leads to limited heating, which will contribute to an extended product lifetime. Other effects are also expected.

The present embodiment is, needless to say, applicable to three or more satellites or satellites transmitting three or more polarized wave signals. The same can be said about the frequency converter 212 generating intermediate frequency signals in three or more frequency ranges.

The present embodiment is, needless to say, applicable to three or more satellites or satellites transmitting three or more polarized wave signals. The same can be said about the frequency converter 212 generating intermediate frequency signals in three or more frequency ranges and the adders 206 adding these signals to generate the first composite signals.

Next, will be described another configuration example to generate the first composite signals.

FIG. 3 shows another configuration which generates the first composite signals. In FIG. 2, the polarized wave signals are converted to a high frequency component and a low frequency component using individual mixers 203, 204. Thereafter, the components are added together in the adders 206. In FIG. 3, one mixer is used to directly convert the polarized wave signals to the first composite signals of a high frequency component and a low frequency component. An adder 305 adds a local oscillator signal output (angular frequency ω1) from the local oscillator 303 and a local oscillator signal output (angular frequency ω2) from the local oscillator 304, to produce a composite signal to be coupled to the mixer 301. The mixer 301 receives a signal input (angular frequency ω0) from a signal source 302 located upstream of the mixer 301. Therefore, the mixer 301 converts that signal input to two intermediate frequency signals with angular frequencies of ω0-ω1 and ω0-ω2.

According to the present embodiment explained above, the LNB 2 includes one or more mixers provided for each polarized wave signal and two or more local oscillators. A mixer multiplies a polarized wave signal by a local oscillator signal output from a local oscillator, to convert the polarized wave signal to an intermediate frequency. The polarized wave signals can be frequency-converted to a plurality of frequency ranges using the one or more mixers and the two or more local oscillators.

Embodiment 3

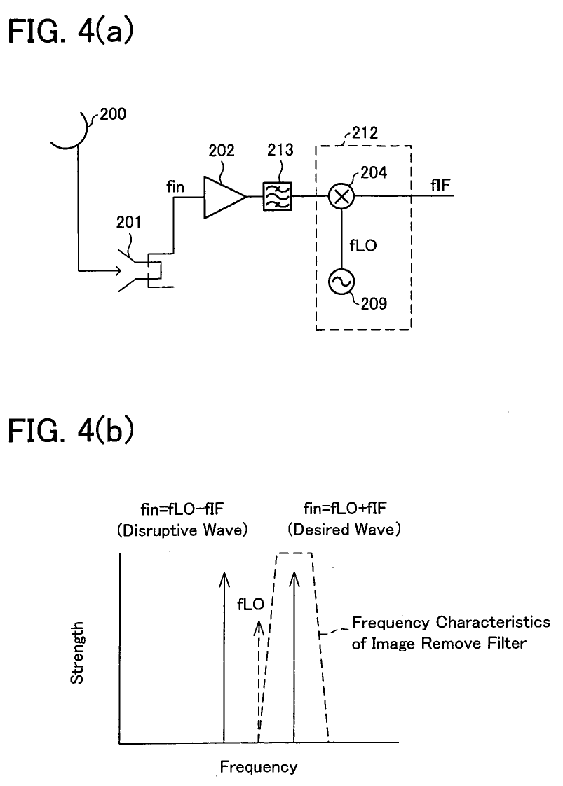

The following will describe another embodiment of the present invention in reference to FIG. 4.

FIG. 4(a) shows a part of an LNB of the present embodiment. The configuration includes image remove filters 213 before the frequency converter 212 in the LNB 1 in FIG. 1 or in the LNB 2 in FIG. 2. Particularly in the figure, the input of the image remove filter 213 is coupled to the output of the amplifiers 202, and the output of the image remove filter 213 is coupled to the input of the frequency converter 212.

In the frequency converter 212 is there shown, as an example, a combination of a mixer 204 and a local oscillator 209. In the figure, “fIF” is a desired intermediate frequency, and “fLO” is a local frequency. Under these circumstances, the desired intermediate frequency fIF can be derived from two input frequencies: fIN=fLO+fIF and fIN=fLO−fIF. Provided that fLO is determined so that the polarized wave signal from the satellite is fIN=fLO+fIF, signals with noise at fLO−fIF is disrupting to the receiving system. The image remove filter 213 removes such noise to improve reception capability as shown in FIG. 4(b).

Embodiment 4

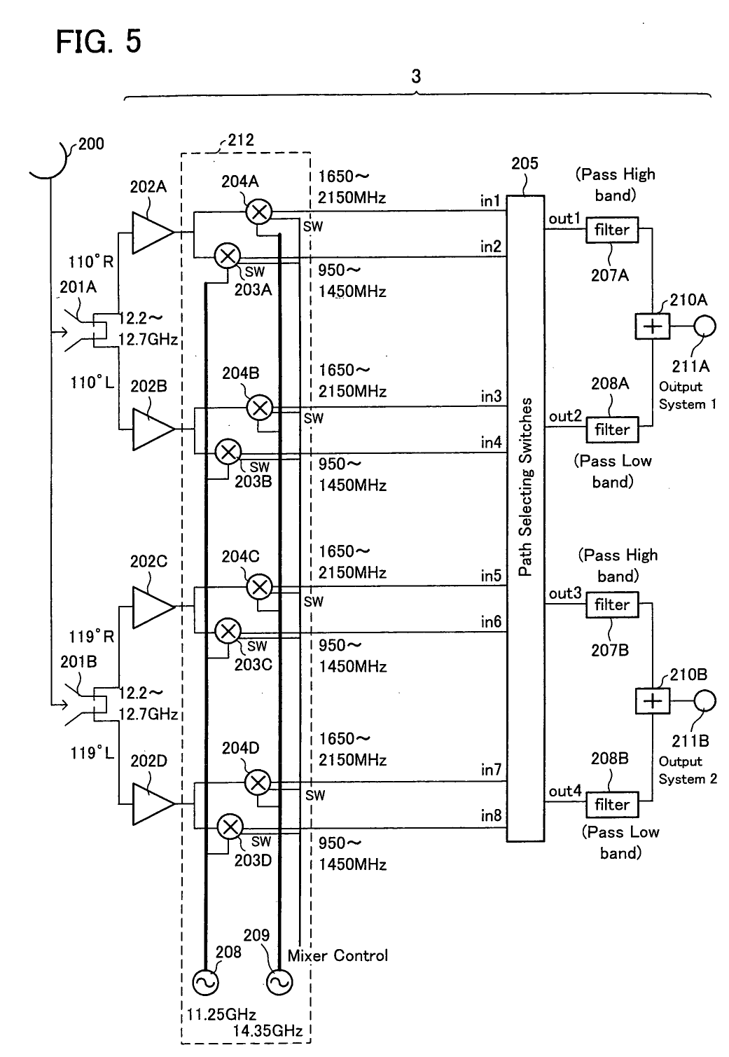

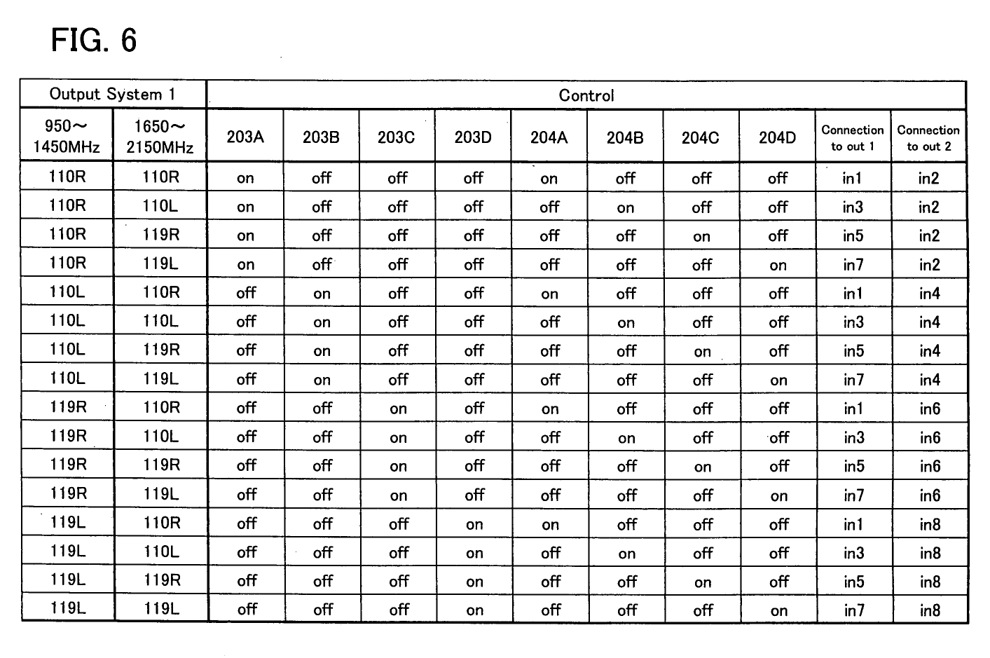

The following will describe another embodiment of the present invention in reference to FIGS. 5 and 6.

FIG. 5 shows the configuration of an LNB 3 in accordance with the present embodiment. The LNB 3, a variation of the LNB 1 in FIG. 1, has the mixers being controlled through switches to stop the operation of mixers being unused. The switches may be, for example, on/off switches for the constant current sources for the mixers. When a mixer is to be used, the switch is turned on to activate the mixer. When the mixer is not to be used, the switch is turned off to deactivate the mixer.

In addition, a filter 207A, or a high frequency component select filter, is provided between the output terminal out1 of the path selecting switches 205 and the adder 210A. A filter 208A, or a low frequency component select filter, is provided between the output terminal out2 of the path selecting switches 205 and the adder 210A. A filter 207B, or a high frequency component select filter, is provided between the output terminal out3 of the path selecting switches 205 and the adder 210B. The filter 208B, or a low frequency component select filter, is provided between the output terminal out4 of the path selecting switches 205 and the adder 210B.

Suppose, for example, a situation where there is no signal output from the output system 2, and one wants to obtain a composite signal of 110° L as the low frequency component and 110° R as the high frequency component from the output system 2. To obtain the desired signal, two paths are used: (1) antenna 200→feedhorn 201A→amplifier 202A→mixer 204A→path selecting switches 205 (in1 connecting to out1)→filter 207A→adder 210A→output terminal 211A, and (2) antenna 200→feedhorn 201A→amplifier 202B→mixer 203B→path selecting switches 205 (in4 connecting to out2)→filter 208A→adder 210A→output terminal 211A. In this situation, the mixers 203A, 203C, 203D, 204B, 204C, and 204D are not being used. The switches are controlled to stop these mixers, to save power consumption.

FIG. 6 shows ON/OFF combinations of the mixers located on the paths to obtain a desired composite signal from output system 1.

This switch control scheme is applicable too to the LNB 2 in FIG. 2.

Embodiment 5

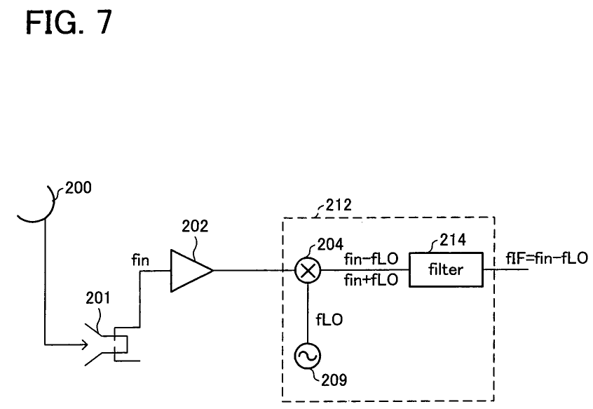

The following will describe another embodiment of the present invention in reference to FIGS. 7 to 9.

FIG. 7 shows a part of an LNB in accordance with the present embodiment. The configuration includes a filter 214 after each mixer in the LNB 1 in FIG. 1 or in the LNB 2 in FIG. 2.

The input of the filter 214 is coupled to the outputs of the associated mixers 203, 204. In FIG. 7, as an example, a combination of a mixer 204 and a local oscillator 209 is shown in the frequency converter 212. In the figure, “fIF” is a desired intermediate frequency, “fLO” is a local frequency, and “fIN” is a polarized wave signal from a satellite. The frequency converter 212 generates a differential component, fIN−fLO, and a sum component, fIN+fLO. Either component that is not needed is removed by the filter 214.

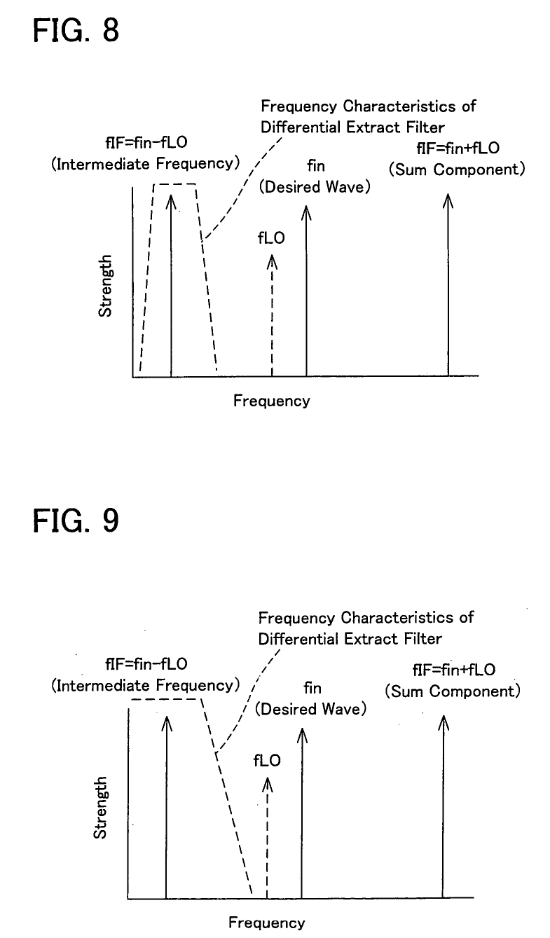

FIG. 8 is an illustration of the relationship of these frequencies. If it is the differential component, fIN−fLO, that is needed, the desired intermediate frequency fiF is obtainable by placing, as the filter 214, a bandpass filter which transmits desired frequencies and remove the unnecessary sum component.

FIG. 9 is another illustration of the relationship of these frequencies. If it is the differential component, fIN−fLO, that is needed, the desired intermediate frequency fIF is obtainable by placing, as the filter 214, a lowpass filter which transmits desired frequencies and remove the unnecessary sum component.

Embodiment 6

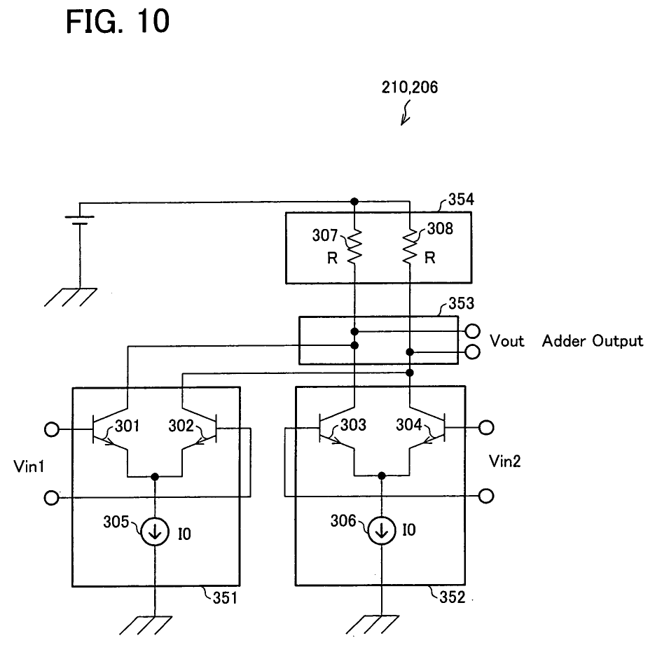

The following will describe another embodiment of the present invention in reference to FIG. 10.

FIG. 10 shows a concrete configuration for the adder 210 in FIGS. 1 and 2 and the adder 206 in FIG. 2.

Each adder 210, 206 contains a first voltage-current conversion section 351, a second voltage-current conversion section 352, a current adder section 353, and a current-voltage conversion section 354.

The first voltage-current conversion section 351 is a differential amplifier containing NPN transistors 301, 302 and a constant current source 305. The transistors 301, 302 constitute a differential pair to which a differential input voltage Vin1 is fed. The constant current source 305 determines the total current flow, IO, through the differential pair. The second voltage-current conversion section 352 is a differential amplifier containing NPN transistors 303, 304 and a constant current source 306. The transistors 303, 304 constitute a differential pair to which a differential input voltage Vin2 is fed. The constant current source 306 determines the total current flow, IO, through the differential pair.

The current adder section 353 connects one of the two output terminals of the first voltage-current conversion section 351 to one of the two output terminals of the second voltage-current conversion section 352 and the remaining output terminal of the section 351 to the remaining output terminal of the section 352, so as to add the collector current of the transistor 301 to the collector current of the transistor 303 and add the collector current of the transistor 302 to the collector current of the transistor 304. The current-voltage conversion section 354 converts the current outputs of the current adder section 353 to voltages with resistors 307, 308 (resistance R). Results are provided as differential outputs (output voltage Vout) of the adders 210, 206.

Letting Vin1=Asinω₁t, and Vin2=Asinω₂t, the adder output is given by:

$$Vout = A \frac{{I}_{0} R}{2 {V}_{T}} ( sin {ω}_{1} t + sin {ω}_{2} t ) \qquad ( 1 )$$

where V_{T} is a heat voltage and V_{T}=kT/q (q is the magnitude of electric charge, k is the Boltzmann's constant, T is absolute temperature).

In this manner, according to the present embodiment, the adders 210, 206 converts a plurality of voltage signals to a plurality of current signals and add the latter to add inputs. The addition is done in the form of current, which makes it easier to secure a dynamic range in the addition. Furthermore, when the currents are later converted back to voltages using resistors, the output voltages are controllable by varying their resistances.

Embodiment 7

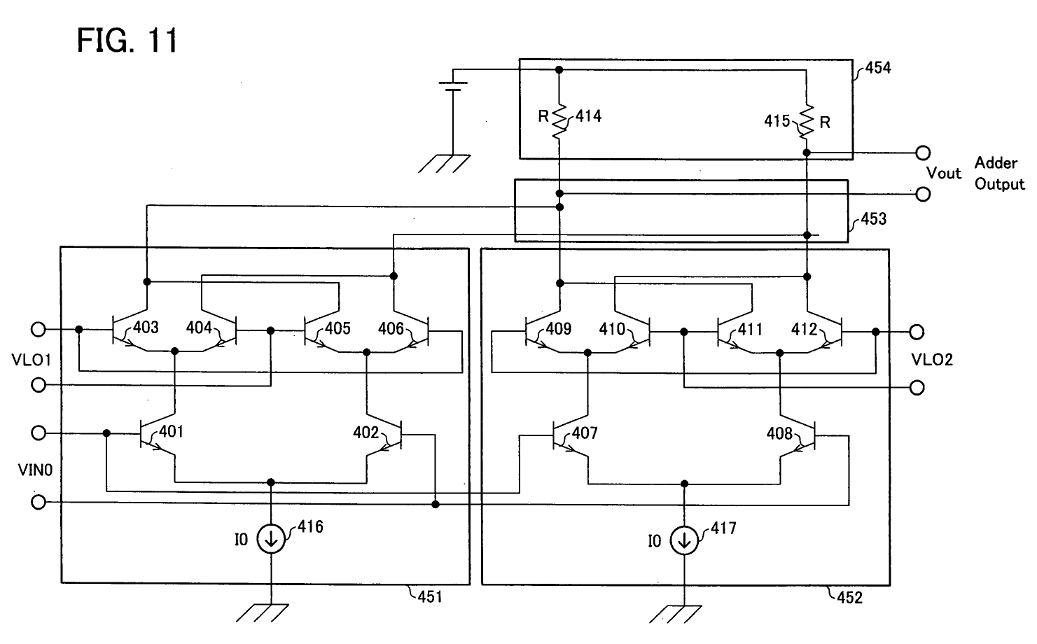

The following will describe another embodiment of the present invention in reference to FIG. 11.

FIG. 11 shows a concrete circuit configuration for implementation of addition in the adder 210 in the LNB 1 in FIG. 1 and in the adder 206 in the LNB 2 in FIG. 2. The circuit includes two mixers 203, 204, an adder 210 or 206.

The circuit includes a first current output frequency converter 451, a second current output frequency converter 452, a current adder section 453, and a current-voltage conversion section 454. The first current output frequency converter 451 is an equivalent of either one of the mixers 203, 204. The second current output frequency converter 452 is an equivalent of the other. The current adder section 453 and the current-voltage conversion section 454 are an equivalent of the adder 210 or 206. If they are the equivalent of the adder 210, a path through the path selecting switches 205 is interposed before the current adder section 453.

The first current output frequency converter 451 is a Gilbert multiplier. The converter 451 includes NPN transistors 401, 402, a constant current source 416, NPN transistors 403, 404, and NPN transistors 405, 406. The transistors 401, 402 make up a differential pair to which a signal VINO is fed for frequency conversion. The constant current source 416 determines a total current flow, IO, through the differential pair. The transistors 403, 404 make up a differential pair, coupled to the collector of the transistor 401, to which a local oscillator signal VLO1 is fed. The transistors 405, 406 make up a differential pair, coupled to the collector of the transistor 402, to which the local oscillator signal VLO1 is fed.

The second current output frequency converter 452 is a Gilbert multiplier. The converter 452 includes NPN transistors 407, 408, a constant current source 417, NPN transistors 409, 410, and NPN transistors 411, 412. The transistors 407, 408 make up a differential pair to which the signal VIN0 is fed for frequency conversion. The constant current source 417 determines a total current flow, I0, through the differential pair. The transistors 409, 410 make up a differential pair, coupled to the collector of the transistor 407, to which a local oscillator signal VLO2 is fed. The transistors 411, 412 make up a differential pair, coupled to the collector of the transistor 408, to which the local oscillator signal VLO2 is fed.

One of the two output terminals of the first current output frequency converter 451 is connected to one of the two output terminals of the second current output frequency converter 452. The remaining output terminal of the converter 451 is connected to the remaining output terminal of the converter 452. The connection enables the current adder section 453 to add the sum of the collector currents of the transistors 403, 405 to the sum of the collector currents of the transistors 409, 411 and to add the sum of the collector currents of the transistors 404, 406 to the sum of the collector currents of the transistors 410, 412. The current-voltage conversion section 454 converts the current outputs of the current adder section 453 to voltages with resistors 414, 415 (resistance R). Results are provided as differential outputs (output voltage Vout) of the adders 210, 206.

Letting Vin0=Asinω₀t, VLO1=Bsinω_{L1}t, and VLO2=Bsinω_{L2}t, the adder output is given by:

$$Vout = \frac{{I}_{0} R}{4 {V}_{T}^{2}} \times \frac{AB}{2} \{ sin ( {ω}_{0} - {ω}_{L 1} ) t - cos ( {ω}_{0} + {ω}_{L 1} ) t + sin ( {ω}_{0} - {ω}_{L 2} ) t - cos ( {ω}_{0} + {ω}_{L 2} ) t \} \qquad ( 2 )$$

Removing the terms involving a sum of frequencies, letting ω₀−ω_{L1}=ω₁ and ω₀−ω_{L2}=ω₂, and collecting the remaining terms, we obtain:

$$Vout = AB \frac{{I}_{0} R}{8 {V}_{T}^{2}} ( sin {ω}_{1} t + sin {ω}_{2} t ) \qquad ( 3 )$$

As detailed above, according to the present embodiment, the adders 210, 206 adds a plurality of current signals to add inputs. The addition is done in the form of current, which makes it easier to secure a dynamic range in the addition. Furthermore, when the currents are later converted back to voltages using resistors, the output voltages are controllable by varying their resistances.

Embodiment 8

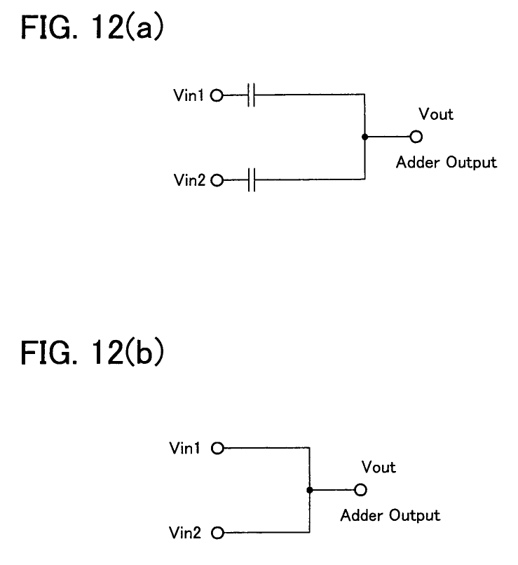

The following will describe another embodiment of the present invention in reference to FIG. 12.

FIGS. 12(a), 12(b) show a configuration for the adders 210, 206 adding a plurality of inputs through AC coupling or DC coupling.

Supposing that the input signals Vin1=Asinω₁t and Vin2=Asinω₂t, the output.signal is given by
Vout=A(sinω₁t+sinω₂t) . . . (4)

According to the present embodiment, voltage signals can be added simply by connecting, which simplifies circuitry.

Embodiment 9

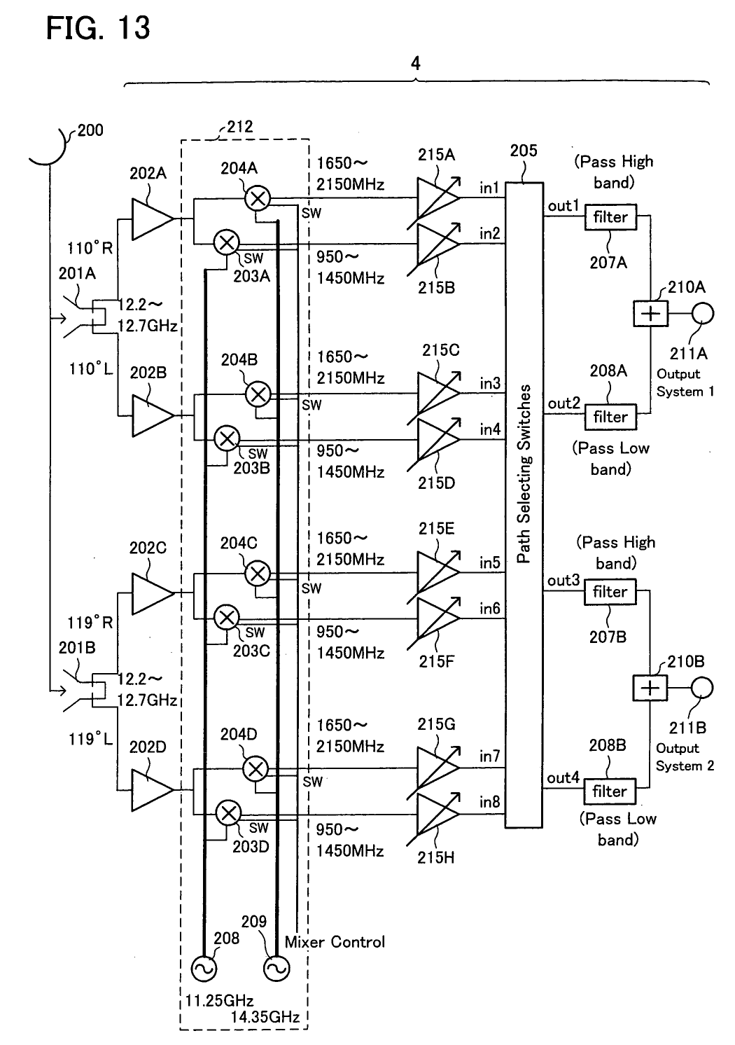

The following will describe another embodiment of the present invention in reference to FIG. 13.

FIG. 13 shows the configuration of an LNB 4 in accordance with the present embodiment.

The LNB 4, when compared to the LNB 3 in FIG. 5, includes additional variable-gain amplifiers 215 (215A to 215H). The variable-gain amplifiers 215 are provided between the frequency converter 212 and the path selecting switches 205. Accordingly, The variable-gain amplifiers 215 adjust the output signal strength of the frequency converter 212 to suitable levels for the circuits located downstream of the variable-gain amplifiers 215.

The variable-gain amplifier 215A amplifies the signal output from the mixer 204A before it is coupled to the input terminal in1 of the path selecting switches 205. The variable-gain amplifier 215B amplifies the signal output from the mixer 203A before it is coupled to the input terminal in2 of the path selecting switches 205. The variable-gain amplifier 215C amplifies the signal output from the mixer 204B before it is coupled to the input terminal in3 of the path selecting switches 205. The variable-gain amplifier 215D amplifies the signal output from the mixer 203B before it is coupled to the input terminal in4 of the path selecting switches 205. The variable-gain amplifier 215E amplifies the signal output from the mixer 204C before it is coupled to the input terminal in5 of the path selecting switches 205. The variable-gain amplifier 215F amplifies the signal output from the mixer 203C before it is coupled to the input terminal in6 of the path selecting switches 205. The variable-gain amplifier 215G amplifies the signal output from the mixer 204D before it is coupled to the input terminal in7 of the path selecting switches 205. The variable-gain amplifier 215H amplifies the signal output from the mixer 203D before it is coupled to the input terminal in8 of the path selecting switches 205.

Embodiment 10

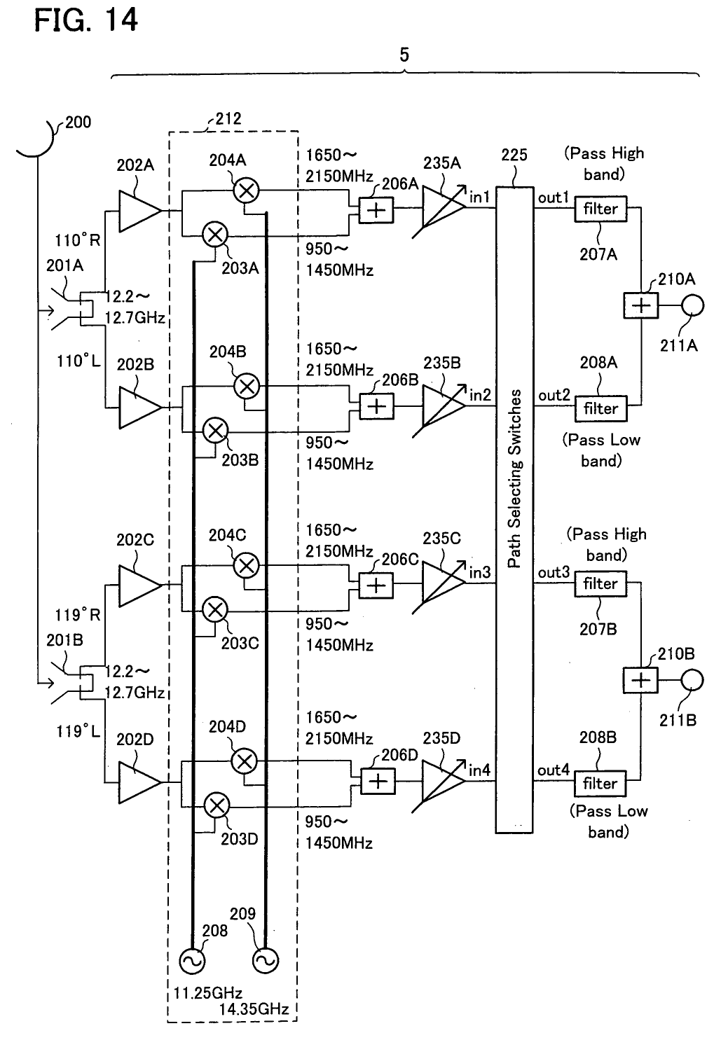

The following will describe another embodiment of the present invention in reference to FIG. 14.

FIG. 14 shows the configuration of an LNB 5 in accordance with the present embodiment.

The LNB 5, when compared to the LNB 2 in FIG. 2, includes additional variable-gain amplifiers 235 (235A to 235D). The variable-gain amplifiers 235 are provided between the adders 206 and the path selecting switches 225. Accordingly, the variable-gain amplifiers 235 adjust the output signal strength of the adders 206 to suitable levels for the circuits located downstream of the variable-gain amplifiers 235.

The variable-gain amplifier 235A amplifies the signal output from the adder 206A before it is coupled to the input terminal in1 of the path selecting switches 225. The variable-gain amplifier 235B amplifies the signal output from the adder 206B before it is coupled to the input terminal in2 of the path selecting switches 225. The variable-gain amplifier 235C amplifies the signal output from the adder 206C before it is coupled to the input terminal in3 of the path selecting switches 225. The variable-gain amplifier 235D amplifies the signal output from the adder 206D before it is coupled to the input terminal in4 of the path selecting switches 225.

Embodiment 11

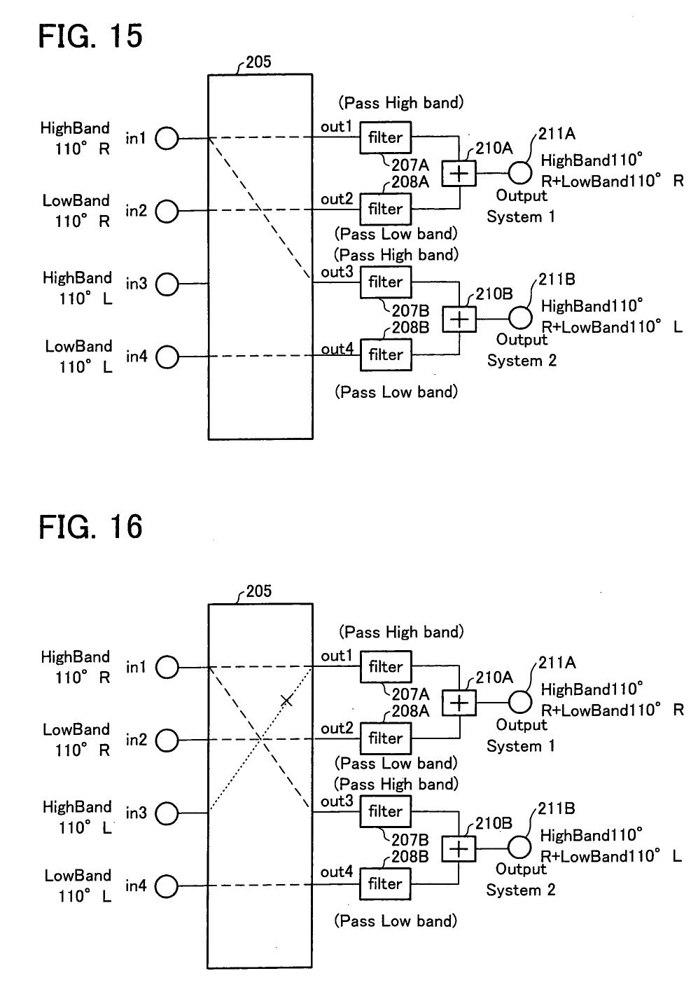

The following will describe another embodiment of the present invention in reference to FIG. 15.

FIG. 15 shows an example of path selection in the path selecting switches 205. The figure shows an example of path selection in the path selecting switches 205 in the LNB 3 in FIG. 5. The same selection is also applicable the path selecting switches 205, 225 in other LNBs. For convenience of description, the path selecting switches 205 are supposed to have four input terminals.

As shown in FIG. 15, the input terminal in1 of the path selecting switches 205 receives the higher intermediate frequency signal of 110° R; the input terminal in2 receives the lower intermediate frequency signal of 110° R; the input terminal in3 receives the higher intermediate frequency signal of 110° L; and the input terminal in4 receives the lower intermediate frequency signal of 110° L. To obtain a frequency-multiplexed composite signal of the lower intermediate frequency signal of 110° R and the higher intermediate frequency signal of 110° R from the output system 1 and a frequency-multiplexed composite signal of the lower intermediate frequency signal of 110° L and the higher intermediate frequency signal of 110° R from the output system 2, the path selecting switches 205 are set up to establish the in1-out1, in1-out3, in2-out2, and in4-out4 paths.

One input terminal may therefore be connected to a plurality of output terminals, as in the case with in1. Such a path selection is acceptable.

According to the present embodiment, the path selecting switches are allowed to connect a single input terminal to a plurality of output terminals. Various signal combinations are simultaneously available with the plurality of adders.

Embodiment 12

The following will describe another embodiment of the present invention in reference to FIG. 16.

FIG. 16 shows an example of prohibited path selection in the path selecting switches 205. The figure shows an example of path selection in the path selecting switches 205 in the LNB 3 in FIG. 5. The same selection is also applicable to the path selecting switches 205, 225 in other LNBs. For convenience of description, the path selecting switches 205 are supposed to have four input terminals.

As shown in FIG. 16, the input terminal in1 of the path selecting switches 205 receives the higher intermediate frequency signal of 110° R; the input terminal in2 receives the lower intermediate frequency signal of 110° R; the input terminal in3 receives the higher intermediate frequency signal of 110° L; and the input terminal in4 receives the lower intermediate frequency signal of 110° L. To obtain a frequency-multiplexed composite signal of the lower intermediate frequency signal of 110° R and the higher intermediate frequency signal of 110° R from the output system 1 and a frequency-multiplexed composite signal of the lower intermediate frequency signal of 110° L and the higher intermediate frequency signal of 110° R from the output system 2, the path selecting switches 205 are set up to establish the in1-out1, in1-out3, in2-out2, and in4-out4 paths. If the in3-out1 path was also established, the higher intermediate frequency signal of 110° R and the higher intermediate frequency signal of 110° L would appear at the output terminal out1. These signals have the same frequency range; the desired signals could not be obtained.

One output terminal may therefore not be connected to a plurality of inputs terminals.

According to the present embodiment, the path selecting switches are prohibited from connecting a single output terminal to a plurality of inputs terminals. The adders never adds signals in the same frequency range.

Embodiment 13

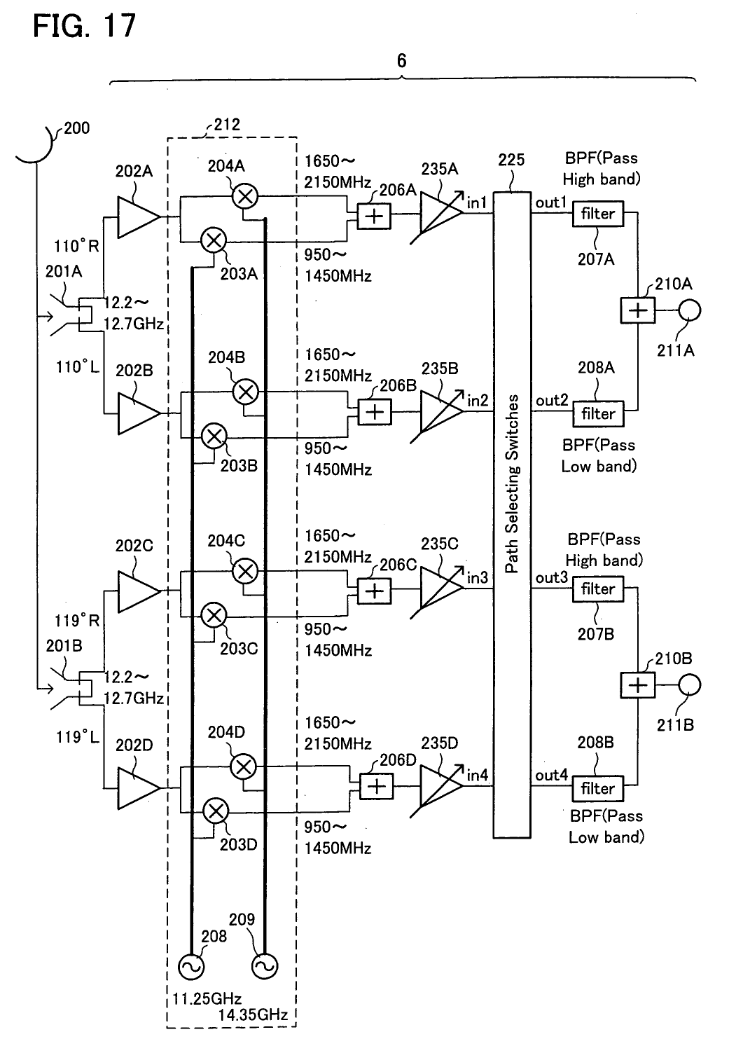

The following will describe another embodiment of the present invention in reference to FIG. 17.

FIG. 17 shows the configuration of an LNB 6 in accordance with the present embodiment. The LNB 6, when compared to the LNB 5 in FIG. 14, includes bandpass filters (BPFs) as the filters 207A, 207B, 208A, 208B.

The path selecting switches 225 output the first frequency-multiplexed composite signals each of which can possibly contain both a lower intermediate frequency component and a higher intermediate frequency component. To derive only a desired frequency range from the first composite signals, the BPFs which transmit only the desired frequency range are used as filters 207A, 207B, 208A, 208B as above. In FIG. 17, the filters 207 (207A, 207B) are BPFs which transmit only the higher intermediate frequency component; the filters 208 (208A, 208B) are BPFs which transmit only the lower intermediate frequency component. By passing signals through these BPFs, no signal inputs to the individual adders 210 have the same frequency range. Thus, the desired second composite signals are obtained from the output terminals 211.

The present embodiment is also applicable to the LNB 2 in FIG. 2.

Embodiment 14

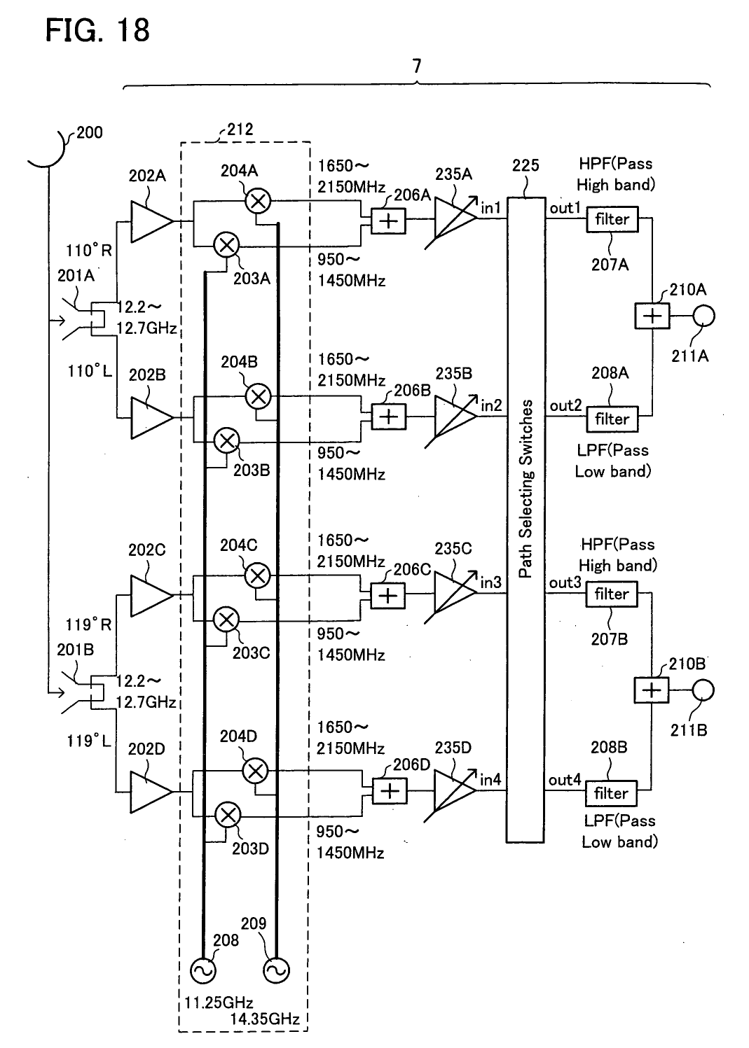

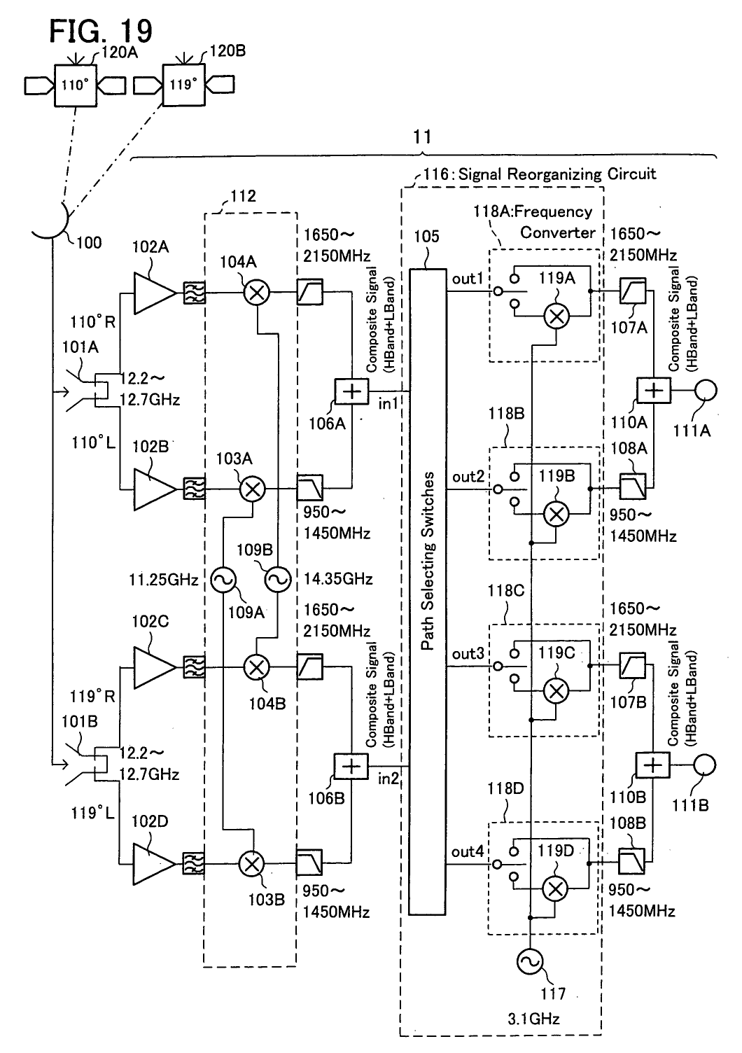

The following will describe another embodiment of the present invention in reference to FIG. 18.

FIG. 18 shows the configuration of the LNB 7 in accordance with the present embodiment. The LNB 7, when compared to the LNB 5 in FIG. 14, includes highpass filters (HPFs) as the filters 207A, 207B and lowpass filters (LPFs) as the filter 208A, 208B.

The path selecting switches 225 output the first frequency-multiplexed composite signals each of which can possibly contain both a lower intermediate frequency component and a higher intermediate frequency component. To derive only a desired frequency range from the first composite signals, the HPFs and LPFs which transmit the desired frequency range and block the unnecessary frequency range are used as the filters 207A, 207B, 208A, 208B.

In FIG. 18, the filters 207 (207A, 207B) are HPFs which transmit the higher intermediate frequency component and block the lower intermediate frequency component; the filters 208 (208A, 208B) are LPFs which transmit the lower intermediate frequency component and block the higher intermediate frequency component. By passing signals through these HPFs and LPFs, no signal inputs to the individual adders 210 have the same frequency range. Thus, the second composite signals in desired high and low frequency ranges are obtained from the output terminals 211.

The present embodiment is also applicable to the LNB 2 in FIG. 2.

As described in the foregoing, a low noise block converter of the present invention receives a plurality of polarized wave signals from a plurality of satellites. The low noise block converter includes: amplifying sections amplifying the plurality of polarized wave signals respectively; a frequency conversion section converting the plurality of polarized wave signals amplified by the amplifying sections into intermediate frequency signals in a plurality of frequency ranges; path selecting switches, provided with input terminals to which are fed the respective intermediate frequency signals generated by the frequency conversion section, which selectively establish paths connecting the input terminals to a plurality of output terminals so that the intermediate frequency signals fed to the input terminals are selectively output at selected ones of the plurality of output terminals; and adders adding more than one output of the path selecting switches to generate composite signals for output.

According to the arrangement, the polarized wave signals are amplified by the amplifying sections for subsequent frequency conversion in the frequency conversion section. The frequency conversion section generates intermediate frequency signals in a plurality of frequency ranges from the polarized wave signals through conversion. The path selecting switches selectively establish paths so that a plurality of intermediate frequency signals with no frequency range overlapping are coupled to the inputs of each adder. The adders generate composite signals in a plurality of frequency ranges with no frequency range overlapping. Therefore, frequency-multiplexed signals are obtained with no signal frequency conversion in the frequency conversion section and later stages.

Hence, an LNB is realized which has limited frequency conversion circuit complexity.

Another low noise block converter of the present invention receives a plurality of polarized wave signals from a plurality of satellites. The low noise block converter includes: amplifying sections amplifying the plurality of polarized wave signals respectively; a frequency conversion section converting the plurality of polarized wave signals amplified by the amplifying sections into intermediate frequency signals in a plurality of frequency ranges; first adders adding the intermediate frequency signals in a plurality of frequency ranges supplied from the frequency conversion section for each polarized wave signal to generate first composite signals for output; path selecting switches, provided with input terminals to which are fed the respective first composite signals generated by the first adders, which selectively establish paths connecting the input terminals to a plurality of output terminals so that the first composite signals fed to the input terminals are selectively output at selected ones of the plurality of output terminals; filters, provided for the respective output terminals of the path selecting switches, through which outputs of the path selecting switches are passed; and second adders adding more than one output of the filters to generate second composite signals for output.

According to the arrangement, the polarized wave signals are amplified by the amplifying sections for subsequent frequency conversion in the frequency conversion section. The frequency conversion section converts the polarized wave signals into intermediate frequency signals in a plurality of frequency ranges. The first adders add the intermediate frequency signals in a plurality of frequency ranges for each polarized wave signal to generate first composite signals. The first composite signals are selectively output at selected output terminals of the path selecting switches. The first composite signals at the output terminals are passed through filters to preserve only some frequency components. A plurality of filter outputs with no frequency range overlapping is fed to each second adder. The second adders generate the second composite signals in a plurality of frequency ranges with no frequency range overlapping. Therefore, frequency-multiplexed signals are obtained with no signal frequency conversion in the frequency conversion section and later stages.

Hence, an LNB is realized which has limited frequency conversion circuit complexity.

The low noise block converter of the present invention may further include an image frequency removing filters provided upstream of the frequency conversion section.

According to the arrangement, the image remove filter removes image signals, thereby achieving improved reception capability.

The low noise block converter of the present invention may be arranged so that: the frequency conversion section includes two or more mixers provided for each polarized wave signal and two or more local oscillators; and the mixer multiplies the plurality of polarized wave signals by local oscillator signals supplied from the local oscillators to frequency-convert the plurality of polarized wave signals to the intermediate frequency signals.

According to the arrangement, the provision of two or more mixers and the two or more local oscillators makes it possible to frequency-convert the polarized wave signals to a plurality of frequency ranges.

The low noise block converter of the present invention may be arranged so that: the frequency conversion section includes one or more mixers provided for each polarized wave signal and two or more local oscillators; and the mixer multiplies the plurality of polarized wave signals by local oscillator signals supplied from the local oscillators to frequency-convert the plurality of polarized wave signals to the intermediate frequency signals.

According to the arrangement, the provision of the one or more mixers and the two or more local oscillators makes it possible to frequency-convert the polarized wave signals to a plurality of frequency ranges.

The low noise block converter of the present invention may be arranged so that the mixers are controllable as to whether to activate or deactivate the mixers.

According to the arrangement, unused mixers are stopped, thereby achieving reduced power consumption.

The low noise block converter of the present invention may be arranged so that the frequency conversion section includes filters provided downstream of the mixer.

According to the arrangement, the filters remove unnecessary frequency components generated in the frequency conversion in the frequency conversion section.

The low noise block converter of the present invention may be arranged so that the filters are bandpass filters.

According to the arrangement, the bandpass filters remove unnecessary frequency components generated in the frequency conversion in the frequency conversion section.

The low noise block converter of the present invention may be arranged so that the filters are lowpass filters.

According to the arrangement, the lowpass filters remove unnecessary frequency components generated in the frequency conversion in the frequency conversion section.

The low noise block converter of the present invention may be arranged so that: each input to the adders is a voltage signal; and the adders add currents obtained through voltage-current conversion of the plurality of voltage signals to add the plurality of inputs.

According to the arrangement, the adders add inputs by converting a plurality of voltage signals to current signals and adding them. The addition is done in the form of current, which makes it easier to secure a dynamic range in the addition. Furthermore, when the currents are later converted back to voltages using resistors, the output voltages are controllable by varying their resistances.

The low noise block converter of the present invention may be arranged so that each input to the first adders and the second adders is a voltage signal; and the first adders and the second adders add currents obtained through voltage-current conversion of the plurality of voltage signals to add the plurality of inputs.

According to the arrangement, the first adders and the second adders add inputs by converting a plurality of voltage signals to current signals and adding them. The addition is done in the form of current, which makes it easier to secure a dynamic range in the addition. Furthermore, when the currents are later converted back to voltages using resistors, the output voltages are controllable by varying their resistances.

The low noise block converter of the present invention may be arranged so that: each input to the adders is a current signal; and the adders add the plurality of current signals to add the plurality of inputs.

According to the arrangement, the adders add inputs by adding a plurality of current signals. The addition is done in the form of current, which makes it easier to secure a dynamic range in the addition. Furthermore, when the currents are later converted back to voltages using resistors, the output voltages are controllable by varying their resistances.

The low noise block converter of the present invention may be arranged so that: each input to the first adders is a current signal; and the first adders add the plurality of current signals to add the plurality of inputs.

According to the arrangement, the first adders add inputs by adding a plurality of current signals. The addition is done in the form of current, which makes it easier to secure a dynamic range in the addition. Furthermore, when the currents are later converted back to voltages using resistors, the output voltages are controllable by varying their resistances.

The low noise block converter of the present invention may be arranged so that the adders add a plurality of inputs to the adders through AC or DC coupling.

According to the arrangement, voltage signals can be added simply by connecting, which simplifies circuitry.

The low noise block converter of the present invention may be arranged so that the first adders add a plurality of inputs to the first adders through AC or DC coupling.

According to the arrangement, voltage signals can be added simply.by connecting, which simplifies circuitry.

The low noise block converter of the present invention may further includes variable-gain amplifiers adjusting the intermediate frequency signals supplied from the frequency conversion section in signal strength for output to the path selecting switches.

According to the arrangement, the variable-gain amplifiers adjust the output signal strength of the frequency conversion section to suitable levels for the circuits provided downstream of the variable-gain amplifiers.

The low noise block converter of the present invention may further include variable-gain amplifiers adjusting the first composite signals supplied from the first adders in signal strength for output to the path selecting switches.

According to the arrangement, the variable-gain amplifiers adjust the output signal strength of the frequency conversion section to suitable levels for the circuits provided downstream of the variable-gain amplifiers.

The low noise block converter of the present invention may be arranged so that the path selecting switches are allowed to connect a single input terminal to a plurality of output terminals.

According to the arrangement, the path selecting switches are allowed to connect a single input terminal to a plurality of output terminals. Various signal combinations are simultaneously available with the plurality of adders.

The low noise block converter of the present invention may be arranged so that the path selecting switches are prohibited from connecting a single output terminal to a plurality of input terminals.

According to the arrangement, the path selecting switches are prohibited from connecting a single output terminal to a plurality of inputs terminals. The adders never adds signals in the same frequency range.

The low noise block converter of the present invention may be arranged so that at least one of the plurality of filters is a bandpass filter transmitting a predetermined frequency component of the first composite signals.

According to the arrangement, the bandpass filter transmits only a desired frequency component of the first composite signals.

The low noise block converter of the present invention may be arranged so that at least one of the plurality of filters is a lowpass filter transmitting a predetermined low frequency component of the first composite signals.

According to the arrangement, the lowpass filter transmits only a desired low frequency component of the first composite signals.

The low noise block converter of the present invention may be arranged so that at least one of the plurality of filters is a highpass filter transmitting a predetermined high frequency component of the first composite signals.

According to the arrangement, the highpass filter transmits only a desired high frequency component of the first composite signals.

The low noise block converter of the present invention may be arranged so that the second adders add a plurality of inputs to the second adders through AC or DC coupling.

According to the arrangement, voltage signals can be added simply by connecting, which simplifies circuitry.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A low noise block converter receiving a plurality of polarized wave signals from a plurality of satellites, said converter comprising:
amplifying sections amplifying the plurality of polarized wave signals respectively;
a frequency conversion section converting the plurality of polarized wave signals amplified by the amplifying sections into intermediate frequency signals in a plurality of frequency ranges;
path selecting switches, provided with input terminals to which are fed the respective intermediate frequency signals generated by the frequency conversion section, which selectively establish paths connecting the input terminals to a plurality of output terminals so that the intermediate frequency signals fed to the input terminals are selectively output at selected ones of the plurality of output terminals; and
adders adding more than one output of the path selecting switches to generate composite signals for output.

2. A low noise block converter receiving a plurality of polarized wave signals from a plurality of satellites, said converter comprising:
amplifying sections amplifying the plurality of polarized wave signals respectively;
a frequency conversion section converting the plurality of polarized wave signals amplified by the amplifying sections into intermediate frequency signals in a plurality of frequency ranges;
first adders adding the intermediate frequency signals in a plurality of frequency ranges supplied from the frequency conversion section for each polarized wave signal to generate first composite signals for output;
path selecting switches, provided with input terminals to which are fed the respective first composite signals generated by the first adders, which selectively establish paths connecting the input terminals to a plurality of output terminals so that the first composite signals fed to the input terminals are selectively output at selected ones of the plurality of output terminals;
filters, provided for the respective output terminals of the path selecting switches, through which outputs of the path selecting switches are passed; and
second adders adding more than one output of the filters to generate second composite signals for output.

3. The low noise block converter of claim 1, further comprising an image frequency removing filter provided upstream of the frequency conversion section.

4. The low noise block converter of claim 2, further comprising an image frequency removing filter provided upstream of the frequency conversion section.

5. The low noise block converter of claim 1, wherein:
the frequency conversion section includes two or more mixers provided for each polarized wave signal and two or more local oscillators; and
the mixer multiplies the plurality of polarized wave signals by local oscillator signals supplied from the local oscillators to frequency-convert the plurality of polarized wave signals to the intermediate frequency signals.

6. The low noise block converter of claim 2, wherein:
the frequency conversion section includes one or more mixers provided for each polarized wave signal and two or more local oscillators; and
the mixer multiplies the plurality of polarized wave signals by local oscillator signals supplied from the local oscillators to frequency-convert the plurality of polarized wave signals to the intermediate frequency signals.

7. The low noise block converter of claim 5, wherein the mixers are controllable as to whether to activate or deactivate the mixers.

8. The low noise block converter of claim 6, wherein the mixers are controllable as to whether to activate or deactivate the mixers.

9. The low noise block converter of claim 5, wherein the frequency conversion section includes filters provided downstream of the mixer.

10. The low noise block converter of claim 6, wherein the frequency conversion section includes filters provided downstream of the mixer.

11. The low noise block converter of claim 9, wherein the filters are bandpass filters.

12. The low noise block converter of claim 10, wherein the filters are bandpass filters.

13. The low noise block converter of claim 9, wherein the filters are lowpass filters.

14. The low noise block converter of claim 10, wherein the filters are lowpass filters.

15. The low noise block converter of claim 1, wherein:
each input to the adders is a voltage signal; and
the adders add currents obtained through voltage-current conversion of the plurality of voltage signals to add the plurality of inputs.

16. The low noise block converter of claim 2, wherein:
each input to the first adders and the second adders is a voltage signal; and
the first adders and the second adders add currents obtained through voltage-current conversion of the plurality of voltage signals to add the plurality of inputs.

17. The low noise block converter of claim 1, wherein:
each input to the adders is a current signal; and
the adders add the plurality of current signals to add the plurality of inputs.

18. The low noise block converter of claim 2, wherein:
each input to the first adders is a current signal; and
the first adders add the plurality of current signals to add the plurality of inputs.

19. The low noise block converter of claim 1, wherein the adders add a plurality of inputs to the adders through AC or DC coupling.

20. The low noise block converter of claim 2, wherein the first adders add a plurality of inputs to the first adders through AC or DC coupling.

21. The low noise block converter of claim 1, further comprising variable-gain amplifiers adjusting the intermediate frequency signals supplied from the frequency conversion section in signal strength for output to the path selecting switches.

22. The low noise block converter of claim 2, further comprising variable-gain amplifiers adjusting the first composite signals supplied from the first adders in signal strength for output to the path selecting switches.

23. The low noise block converter of claim 1, wherein the path selecting switches are allowed to connect a single input terminal to a plurality of output terminals.

24. The low noise block converter of claim 2, wherein the path selecting switches are allowed to connect a single input terminal to a plurality of output terminals.

25. The low noise block converter of claim 1, wherein the path selecting switches are prohibited from connecting a single output terminal to a plurality of input terminals.

26. The low noise block converter of claim 2, wherein the path selecting switches are prohibited from connecting a single output terminal to a plurality of input terminals.

27. The low noise block converter of claim 2, wherein at least one of the plurality of filters is a bandpass filter transmitting a predetermined frequency component of the first composite signals.

28. The low noise block converter of claim 2, wherein at least one of the plurality of filters is a lowpass filter transmitting a predetermined low frequency component of the first composite signals.

29. The low noise block converter of claim 2, wherein at least one of the plurality of filters is a highpass filter transmitting a predetermined high frequency component of the first composite signals.

30. The low noise block converter of claim 2, wherein the second adders add a plurality of inputs to the second adders through AC or DC coupling.
